(19) United States
(12) Patent Application Publication
(10) Pub. No.: US 2015/0382190 A1
(43) Pub. Date: Dec. 31, 2015

(54) ENHANCED SECURE IDENTITY GENERATION

(71) Applicant: QUALCOMM Incorporated, San Diego, CA (US)

(72) Inventors: Michael-David Nakayoshi Canoy, San Diego, CA (US); Stephen Alton Sprigg, Poway, CA (US); Paul E. Jacobs, San Diego, CA (US); Matthew Stuart Grob, La Jolla, CA (US)

(21) Appl. No.: 14/314,627

(22) Filed: Jun. 25, 2014

(51) Int. Cl. H04W 12/06

(52) U.S. Cl. CPC H04W 12/06

(57) ABSTRACT

An authentication system includes a first authentication key associated with a first device, the first authentication key having a corresponding authentication level, a second authentication key associated with a second device, the second authentication key having a corresponding authentication level, and an enhanced authentication key generated when the first and second authentication keys are combined, the enhanced authentication key having an authentication level that represents a higher authentication level than the authentication level of the first authentication key and the authentication level of the second authentication key.

### DESCRIPTION OF THE RELATED ART

Mobile devices, such as wireless communication devices continue to proliferate. One of the continuing challenges is the authentication of the mobile device to its owner, or to another allowed user, particularly when using the mobile device to perform financial, or other secure transactions.

Current mechanisms for associating a mobile device to its owner involve local authentication, such as direct input or biometric input. This generally reduces the security of the device in that loss or theft of the device implies loss of control over the data on the device. This in turn limits the viability of the device as a truly personal extension of the owner. In addition to mobile communication devices, wearable electronic devices are also beginning to proliferate. Examples of wearable electronic devices include a wristwatch, glasses, biometric monitoring devices, etc. These devices frequently include at least some type of electronic memory, and in some cases include processing capability. In addition, communications technology now permits one or more of these devices to be interconnected via one or more wireless connections that allow these devices to intelligently communicate, and in some instances, to interoperate.

However, it is difficult for these devices to cooperate in providing authentication mechanisms.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1A is a block diagram illustrating an exemplary embodiment of a system for implementing enhanced secure identity generation.

FIG. 1B is a block diagram illustrating an alternative exemplary embodiment of a system for implementing enhanced secure identity generation.

FIG. 2 is a schematic diagram illustrating another exemplary embodiment of a system for implementing enhanced secure identity generation.

FIG. 3 is a block diagram illustrating an example of a wireless device in which aspects of the system for implementing enhanced secure identity generation can be implemented.

FIG. 4 is a block diagram illustrating another exemplary embodiment of a wireless device in which aspects of the system for implementing enhanced secure identity generation can be implemented.

FIG. 5 is a block diagram illustrating another exemplary embodiment of a wireless device in which aspects of the system for implementing enhanced secure identity generation can be implemented.

FIG. 6 is a schematic diagram illustrating an exemplary embodiment of a system for implementing enhanced secure identity generation.

FIG. 7 is a flow chart describing the operation of an embodiment of a method for implementing enhanced secure identity generation.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user device” and “client device” include a device that can be capable of receiving content from a web site or server and transmitting information to a website or server. A user device may also be a wearable device that can interact with other user devices, whether or not being connected to, or able to connect to a web site or server. A user device or client device can be a stationary device, a mobile device, a wearable device, or another device. The terms “user device” and “client device” can be used interchangeably.

As used herein, the term “user” refers to an individual using or wearing a user device. In some applications, a user can receive content on a user device or on a client device and can transmit information to a website or server or to another user device.

As used herein, the term “context” refers to any or all attributes of the user or the user device, such as physical, logical, social, historical and other contextual information.

As used herein, the terms “context aware metadata” and “contextual metadata” refer to metadata that describes or defines the context of a user or a user device.

As used herein, the term “context aware content” refers to content that is delivered to a user device and that is tailored to a user's context.

As used herein, the term “contextual data” refers to one or more of user profile information, user preference information and user context information.

As used herein, the term “proximity” refers to one or more of the location and/or relationship between a user or a user device and its environment, a user or a user device's relationship to another user or another user device or a user or a user device's relationship to another item, device, token, etc.

As used herein, the term “authentication” refers to associating or otherwise verifying an identity of a user and a user device.

As used herein, the term “authentication level” refers to one or more levels of verifying the security and identity of a user and a user device.

As used here, the terms “token,” “key” and “authentication key” refer to an electronic marker or file that can be contained in, or that can be generated by and contained in a user device. The electronic marker or file can be dynamic, static, stand-alone, or able to be combined with one or more other electronic markers or files to define one or more authentication levels for one or more user devices and/or users.

As used here, the terms “new key” and “enhanced key” refer to a “token,” “key” and “authentication key” that is generated from two or more “tokens,” “keys” or “authentication keys.”

As used here, the term “digital identity” refers to an electronic association between a user and a user device, the digital identity generally having an authentication level.

Exemplary embodiments of the system for implementing enhanced secure identity generation involve associating a user's wireless device with other devices worn or carried by the user to develop a more accurate and robust identity for the device and thus a more secure and reliable digital identity for the user.

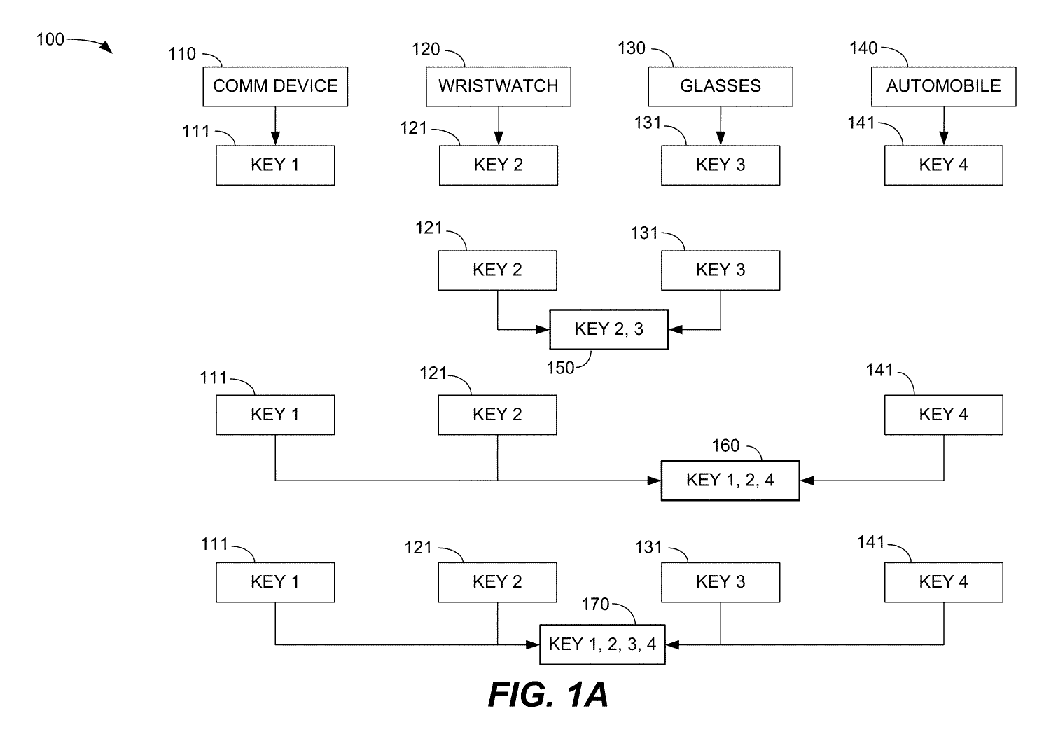

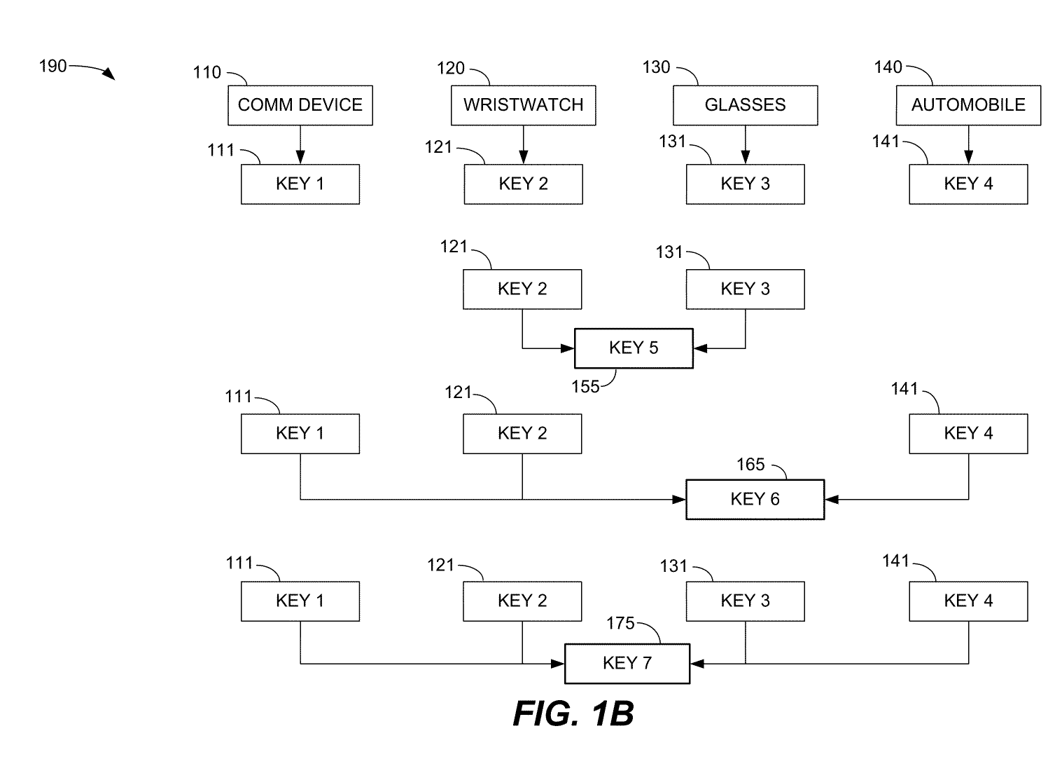

FIG. 1A is a block diagram illustrating an exemplary embodiment of a system for implementing enhanced secure identity generation. The system 100 comprises user devices 110, 120, 130 and 140. More or fewer user devices can be implemented with four user devices being described in FIG. 1A for simplicity of illustration. In an exemplary embodiment, the user devices comprise a communication device 110, a wristwatch 120, a pair of glasses 130 and an automobile 140. In this exemplary embodiment, the user devices 120 and 130 are examples of wearable devices. In an exemplary embodiment, each user device 110, 120, 130 and 140 includes a respective authentication key (also referred to as a “key”) 111, 121, 131 and 141. Each key may contain unique information identifying the user device that it is associated with, and may also include information relating to the user of the particular device. In addition, a key may be generated based on other factors, such as biometric factors such as heart rate, blood pressure, etc.

Each authentication key can be stored in a respective user device. In some embodiments, a user device may include a key generator configured to allow the user device to generate one or more authentication keys. In other embodiments, a user device may only store an authentication key. In some embodiments, the authentication key can be static in that once created it remains in its as-created state. In other embodiments, the authentication key can be dynamic in that it may linger for a period of time, may evolve over time, and may expire after a predetermined amount of time. Each user device may be able to store a previously created authentication key, and in some embodiments, may also be able to generate and store one or more enhanced authentication keys. An authentication key can be a relatively simple passive circuit device, such as a radio frequency identification (RFID) tag, or may be a complex digital code or data stream.

In the embodiment shown in FIG. 1A, each authentication key 111, 121, 131 and 141 has a related authentication level and associated privileges. For example, the authentication key 111 generated by the communication device 110 may have a first authentication level with first privileges. Similarly, each of the authentication keys 121, 131 and 141 may also have a first authentication level that may be the same or different than the first authentication level of the key 111 and may have first privileges that may be the same or different than the first privileges of the key 111. Moreover, the authentication levels and privileges of the keys 121, 131 and 141 may be the same or can be different.

In an exemplary embodiment, the presence of two or more of the authentication keys 111, 121, 131 and 141 in one or more user devices can be recognized and used to create an authentication level greater than the authentication level of any of the authentication keys 111, 121, 131 and 141 alone. In another exemplary embodiment, two or more of the authentication keys 111, 121, 131 and 141 may be combined in one or more user devices to generate, develop or create an enhanced authentication key having an authentication level greater than the authentication level of the authentication keys that were used to generate the enhanced authentication key. The recognized presence of two or more of the authentication keys 111, 121, 131 and 141 or the enhanced authentication key 150 may create second privileges that are greater than the first privileges associated with any of the authentication keys 111, 121, 131 and 141. The term “combined” includes the recognized presence of two or more of the authentication keys 111, 121, 131 and 141, or the mathematical combination of the authentication keys 111, 121, 131 and 141 to generate a completely new authentication key.

For example, the authentication key 121 and the authentication key 131 may be combined in the user device 120 to generate an enhanced authentication key 150 that comprises aspects of the authentication keys 121 and 131, and in an exemplary embodiment, comprises the set of authentication key 121 and authentication key 131. The enhanced authentication key 150 may have an associated authentication level that is higher than, or greater than the authentication level of either authentication key 121 and 131. In this exemplary embodiment where the user device 120 is a wristwatch and the user device 130 is a pair of glasses, the enhanced authentication key 150 may allow the user to make a limited purchase, whereas neither the authentication key 121 nor the authentication key 131 alone would allow such a purchase. In this exemplary embodiment, the combination of a user wearing the wristwatch (user device 120) and the glasses (user device 130) allows the generation of the enhanced key 150, which allows the user to perform limited financial transactions. In an exemplary embodiment, the enhanced key 150 can comprise the set of the authentication key 121 and the authentication key 131. In other exemplary embodiments, the enhanced key 150 can comprise a mathematical transformation of the authentication key 121 and the authentication key 131 to generate a new enhanced key. An example of such a mathematical transformation can be a hash function, or another mathematical transformation. In an exemplary embodiment, the presence of the authentication key 121 and the authentication key 131 may need to satisfy a temporal requirement, such as being proximate to each other for a defined period of time, or within a defined period of time, before the enhanced key 150 can be generated. For example, the wristwatch 120 having the authentication key 121 and the glasses 130 having the authentication key 131 may have to satisfy one or more of a temporal requirement and a proximal requirement with respect to each other before the enhanced key 150 is present.

In a similar manner, the authentication key 111, the authentication key 121 and the authentication key 141 may be combined in the user device 110 or the user device 140 to generate an enhanced authentication key 160 that comprises aspects of the authentication keys 111, 121 and 141, and in an exemplary embodiment, comprises the set of authentication key 121, authentication key 131 and authentication key 141. The enhanced authentication key 160 may comprise the recognized presence of the authentication keys 111, 121 and 141. The enhanced authentication key 160 may have an associated authentication level that is higher than, or greater than the authentication level of any one or two of the authentication keys 111, 121 and 141. In this exemplary embodiment where the user device 110 is a communication device, the user device 120 is a wristwatch and the user device 140 is an automobile, the enhanced authentication key 160 may allow the user to open their garage door using the user device 110 or the user device 140 based on the combination of the three authentication keys 111, 121 and 141, whereas no combination of fewer than the authentication key 111, the authentication key 121 and the authentication key 141 alone would allow such an action.

In a similar manner, the authentication key 111, authentication key 121, authentication key 131 and the authentication key 141 may be combined to generate an enhanced authentication key 170 that comprises aspects of the authentication keys 111, 121, 131 and 141, and in an exemplary embodiment, comprises the set of authentication key 111, authentication key 121, authentication key 131 and authentication key 141. The enhanced authentication key 170 may comprise the recognized presence of the authentication keys 111, 121, 131 and 141. The enhanced authentication key 170 may have an associated authentication level that is higher than, or greater than the authentication level of any of the authentication keys 111, 121, 131 and 141, individually or in any combination other than the four keys. In this exemplary embodiment where the user device 110 is a communication device, the user device 120 is a wristwatch, the user device 130 is a pair of glasses and the user device 140 is an automobile, the enhanced authentication key 170 may allow the user to perform on-line stock trading based on the combination of the four authentication keys 111, 121, 131 and 141, whereas no combination of fewer than the authentication key 111, the authentication key 121, the authentication key 131 and the authentication key 141 would allow such an action.

FIG. 1B is a block diagram illustrating an alternative exemplary embodiment of a system for implementing enhanced secure identity generation. The system 190 is similar to the system 100 described in FIG. 1A.

In an exemplary embodiment, two or more of the authentication keys 111, 121, 131 and 141 may be combined in one or more user devices to generate, develop or create an enhanced authentication key having an authentication level greater than the authentication level of the authentication keys that were used to generate the enhanced authentication key. The enhanced authentication key 155 may create second privileges that are greater than the first privileges associated with any of the authentication keys 111, 121, 131 and 141.

For example, the authentication key 121 and the authentication key 131 may be combined in the user device 120 to generate an enhanced authentication key 155 that comprises aspects of the authentication keys 121 and 131, but that is a mathematical combination of the authentication keys 121 and 131, resulting in the enhanced authentication key 155 being an entirely new key. The enhanced authentication key 155 may have an associated authentication level that is higher than, or greater than the authentication level of either authentication key 121 and 131. In this exemplary embodiment where the user device 120 is a wristwatch and the user device 130 is a pair of glasses, the enhanced authentication key 155 may allow the user to make a limited purchase, whereas neither the authentication key 121 nor the authentication key 131 alone would allow such a purchase. In this exemplary embodiment, the combination of a user wearing the wristwatch (user device 120) and the glasses (user device 130) allows the generation of the enhanced key 155, which allows the user to perform limited financial transactions. In an exemplary embodiment, the enhanced key 155 can comprise a mathematical transformation of the authentication key 121 and the authentication key 131 to generate a new enhanced key. An example of such a mathematical transformation can be a hash function, or another mathematical transformation. In an exemplary embodiment, the presence of the authentication key 121 and the authentication key 131 may need to satisfy a temporal requirement, such as being proximate to each other for a defined period of time, or within a defined period of time, before the enhanced key 155 can be generated. For example, the wristwatch 120 having the authentication key 121 and the glasses 130 having the authentication key 131 may have to satisfy one or more of a temporal requirement and a proximal requirement with respect to each other before the enhanced key 155 is present.

In a similar manner, the authentication key 111, authentication key 121 and the authentication key 141 may be combined in the user device 110 or the user device 140 to generate an enhanced authentication key 165 that comprises aspects of the authentication keys 111, 121 and 141, but that is a mathematical combination of the authentication keys 111, 121 and 141, resulting in the enhanced authentication key 165 being an entirely new key. The enhanced authentication key 165 may have an associated authentication level that is higher than, or greater than the authentication level of any one or two of the authentication keys 111, 121 and 141. In this exemplary embodiment where the user device 110 is a communication device, the user device 120 is a wristwatch and the user device 140 is an automobile, the enhanced authentication key 165 may allow the user to open their garage door using the user device 110 or the user device 140 based on the combination of the three authentication keys 111, 121 and 141, whereas no combination of fewer than the authentication key 111, the authentication key 121 and the authentication key 141 alone would allow such an action.

In a similar manner, the authentication key 111, authentication key 121, authentication key 131 and the authentication key 141 may be combined to generate an enhanced authentication key 175 that comprises aspects of the authentication keys 111, 121, 131 and 141, but that is a mathematical combination of the authentication keys 111, 121, 131 and 141, resulting in the enhanced authentication key 175 being an entirely new key. The enhanced authentication key 175 may have an associated authentication level that is higher than, or greater than the authentication level of any of the authentication keys 111, 121, 131 and 141, individually or in any combination other than the four keys. In this exemplary embodiment where the user device 110 is a communication device, the user device 120 is a wristwatch, the user device 130 is a pair of glasses and the user device 140 is an automobile, the enhanced authentication key 175 may allow the user to perform on-line stock trading based on the combination of the four authentication keys 111, 121, 131 and 141, whereas no combination of fewer than the authentication key 111, the authentication key 121, the authentication key 131 and the authentication key 141 would allow such an action.

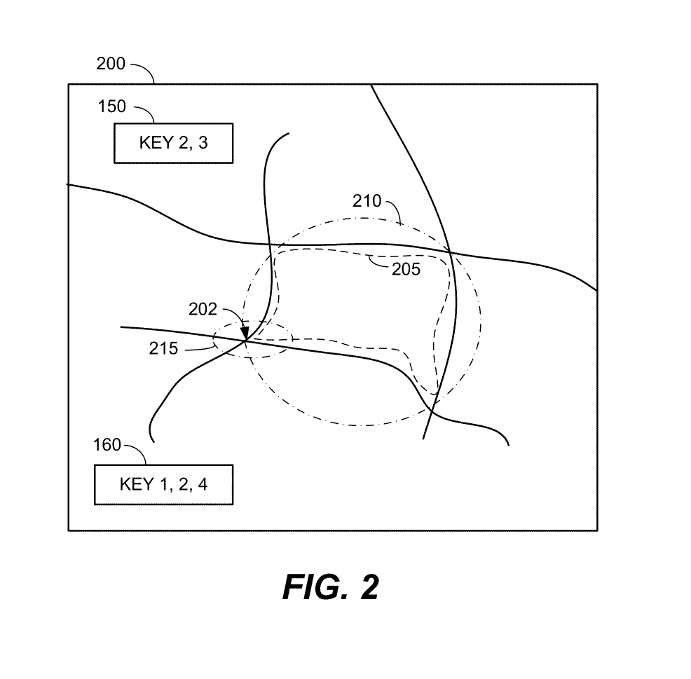

FIG. 2 is a schematic diagram illustrating another exemplary embodiment of a system for implementing enhanced secure identity generation. FIG. 2 shows a map portion 200 illustrating a location 202 of an individual's home and an exemplary route 205. In an exemplary embodiment, the route 205 may be a jogging route, or another travel route. In an exemplary embodiment, a proximity field 210 may encompass the route 205. The proximity field 210 can be associated with the enhanced key 150 that would allow a user to make a limited purchase as described above only when the user is within the proximity field 210 and wearing the wristwatch (user device 120) and the glasses (user device 130). Examples of ways of generating and maintaining a proximity field include, but are not limited to, the use of a geofence, proximity beacons using wireless transmission detection, visual recognition, or any technology that can identify a location.

In another exemplary embodiment, a proximity field 215 may encompass the location 202. The proximity field 215 can be associated with the enhanced key 160 that would allow a user to open their home garage door so long as they are within the proximity field 215, in possession of the communication device (user device 110), wearing the wristwatch (user device 120) and in the automobile (user device 140). In exemplary embodiments, at least two of the first authentication keys can be combined to generate the enhanced key 160 when at least two of the first authentication keys are proximate to a particular geographical region, based on time of day, when they are proximate to each other, or any combination of these.

In an exemplary embodiment in which an enhanced key can be time-dependent, the enhanced key 150 may only allow the related authentication during certain days and times, or only during daylight hours. Further, the enhanced key 160 may be disabled when the user is away from home for a period of time.

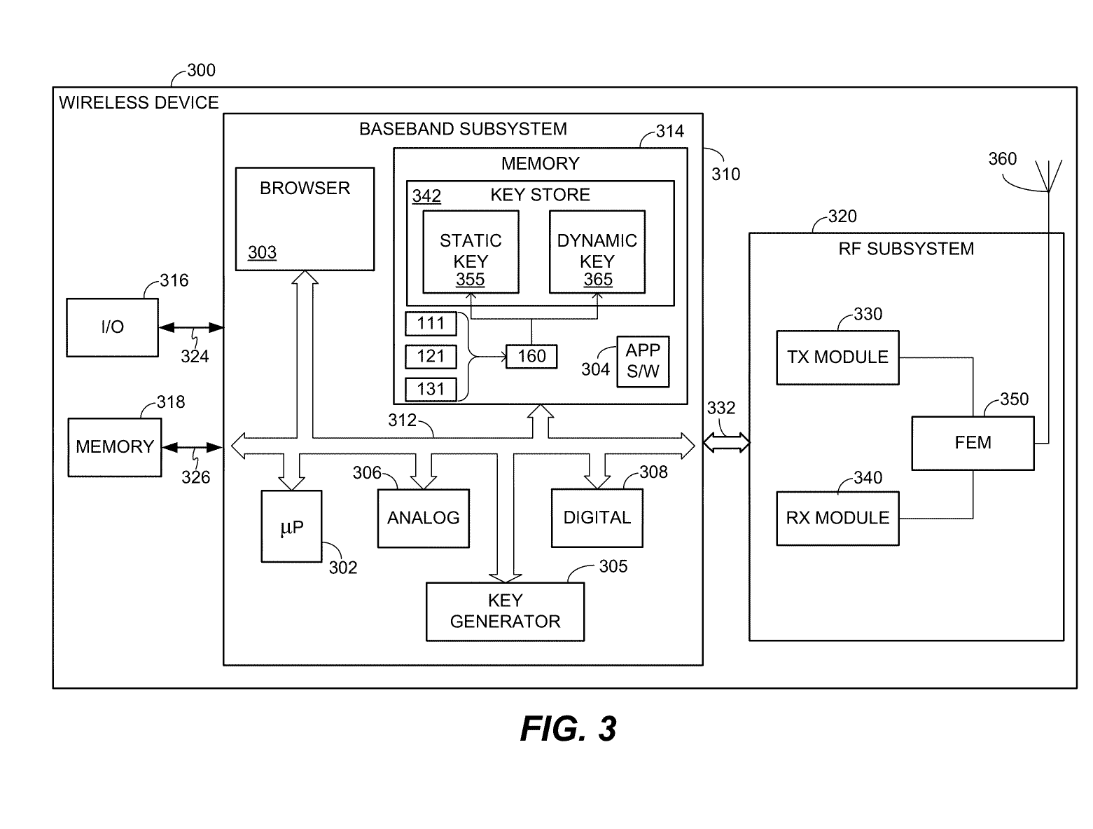

FIG. 3 is a block diagram illustrating an example of a wireless device 300 in which aspects of the system for implementing enhanced secure identity generation can be implemented. In an embodiment, the wireless device 300 can be a “Bluetooth” wireless communication device, a portable cellular telephone, a WiFi enabled communication device, or can be any other communication device. Embodiments of the system for implementing enhanced secure identity generation can be implemented in any communication device. The wireless device 300 illustrated in FIG. 3 is intended to be a simplified example of a cellular telephone and to illustrate one of many possible applications in which the system for implementing enhanced secure identity generation can be implemented. One having ordinary skill in the art will understand the operation of a portable cellular telephone, and, as such, implementation details are omitted. In an embodiment, the wireless device 300 includes a baseband subsystem 310 and an RF subsystem 320 connected together over a system bus 332. The system bus 332 can comprise physical and logical connections that couple the above-described elements together and enable their interoperability. In an embodiment, the RF subsystem 320 can be a wireless transceiver. Although details are not shown for clarity, the RF subsystem 320 generally includes a transmit module 330 having modulation, upconversion and amplification circuitry for preparing a baseband information signal for transmission, includes a receive module 340 having amplification, filtering and downconversion circuitry for receiving and downconverting an RF signal to a baseband information signal to recover data, and includes a front end module (FEM) 350 that includes diplexer circuitry, duplexer circuitry, or any other circuitry that can separate a transmit signal from a receive signal, as known to those skilled in the art. An antenna 360 is connected to the FEM 350.

The baseband subsystem 310 generally includes a processor 302, which can be a general purpose or special purpose microprocessor, memory 314, application software 304, analog circuit elements 306, digital circuit elements 308, and a key generator 305 coupled over a system bus 312. The system bus 312 can comprise the physical and logical connections to couple the above-described elements together and enable their interoperability. The key generator 305 can comprise software, hardware, or a combination of software and hardware that comprises logic to generate one or more authentication keys described herein.

An input/output (I/O) element 316 is connected to the baseband subsystem 310 over connection 324, and a memory element 318 is coupled to the baseband subsystem 310 over connection 326. The I/O element 316 can include, for example, a microphone, a keypad, a speaker, a pointing device, user interface control elements, and any other devices or system that allow a user to provide input commands and receive outputs from the wireless device 300.

The memory 318 can be any type of volatile or non-volatile memory, and in an embodiment, can include flash memory. The memory 318 can be permanently installed in the wireless device 300, or can be a removable memory element, such as a removable memory card.

The processor 302 can be any processor that executes the application software 304 to control the operation and functionality of the wireless device 300. The memory 314 can be volatile or non-volatile memory, and in an embodiment, can be non-volatile memory that stores the application software 304.

The analog circuitry 306 and the digital circuitry 308 include the signal processing, signal conversion, and logic that convert an input signal provided by the I/O element 316 to an information signal that is to be transmitted. Similarly, the analog circuitry 306 and the digital circuitry 308 include the signal processing elements used to generate an information signal that contains recovered information from a received signal. The digital circuitry 308 can include, for example, a digital signal processor (DSP), a field programmable gate array (FPGA), or any other processing device. Because the baseband subsystem 310 includes both analog and digital elements, it can be referred to as a mixed signal device (MSD).

The baseband subsystem 310 also comprises an instance of a web browser 303. The memory 314 comprises a key store 342. In an example embodiment, the key store 342 electronically stores at least one of a static key 355 and a dynamic key 365. In an exemplary embodiment, the static key 355 can be an RFID tag, or can be any other persistent authentication key. In an exemplary embodiment, the dynamic key 365 can contain authentication information that is generated by the key generator 305 either once, or repeatedly. In an embodiment, the dynamic key 365 can be what is referred to as a “rolling key” in which instances of the dynamic key 365 differ from previous iterations of the dynamic key 365.

An enhanced authentication key is generated by combining the digital identity of the subject device, such as a handset or tablet (or other device that can access a network), with the digital identity of other devices carried or worn by the owner (sunglasses, wristwatch, ring, etc.). The enhanced key can then be used for basic authentication or access to remote applications such as mobile banking or retail purchases. When these user devices are detected as being proximate to each other, their associated identities in the form of their authentication keys are combined with the authentication key of the mobile communication device to generate the enhanced authentication key. Conversely, when one or more of these devices is not detected, an authentication key(s) may not be generated. In an alternative exemplary embodiment, when one or more of these devices is not detected a weaker key could be generated that could be rejected or accepted by the device/site that is subject to being accessed. Accessing different resources may have differing levels of security. This serves to prevent access to the device or specific applications or services on the device or on remote servers when the handset/tablet is accessed by an unauthorized user. This strengthens the overall security of the handset/tablet, dramatically reducing the risk of compromise of lost or stolen devices. An example is shown in FIG. 3 where the authentication keys 111, 121 and 131 are present in the key store 342 and are combined to generate the enhanced authentication key 160. The enhanced authentication key 160 can be stored as either the static key 355 or the dynamic key 365.

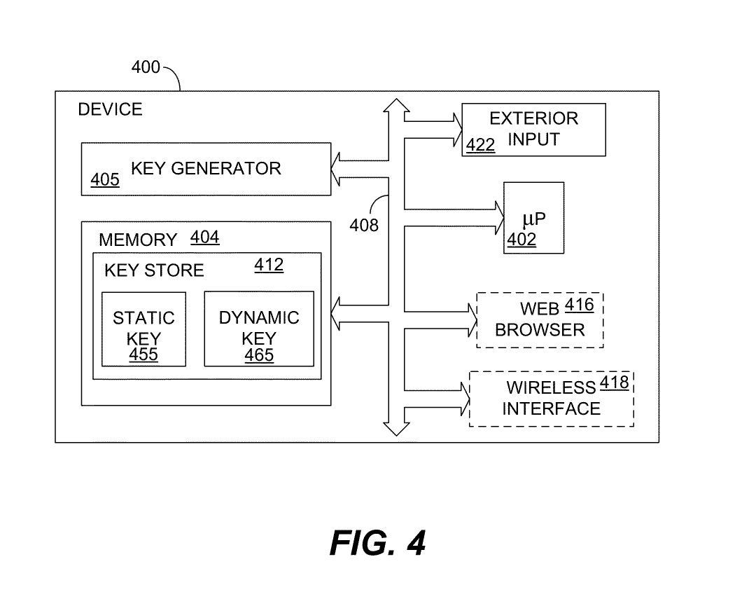

FIG. 4 is a block diagram illustrating another exemplary embodiment of a wireless device 400 in which aspects of the system for implementing enhanced secure identity generation can be implemented. In an embodiment, the wireless device 400 can be a “Bluetooth” wireless communication device, a portable cellular telephone, a WiFi enabled communication device, a wearable device, or can be any other electronic device. The wireless device 400 illustrated in FIG. 4 is intended to be a simplified example of a wearable device such as a wristwatch or glasses that can comprise exemplary embodiments of the system for implementing enhanced secure identity generation.

In an embodiment, the wireless device 400 includes a processor 402, a memory 404 and a key generator 405 operatively connected over a system bus 408. The system bus 408 can comprise physical and logical connections that couple the above-described elements together and enable their interoperability.

The memory 404 can be volatile or non-volatile memory, and in an embodiment, can be non-volatile memory that includes a key store 412. In an example embodiment, the key store 412 may store a static key 455 and/or a dynamic key 465. In an exemplary embodiment, the static key 455 can be an RFID tag, or can be any other persistent authentication key. In an exemplary embodiment, the dynamic key 465 can contain authentication information that is generated by the key generator 405 either once, or repeatedly, or can be a rolling key that changes based on time, or other factors.

The processor 402 can be any processor that executes application software (not shown) to control the operation and functionality of the wireless device 400. The processor 402 can also execute the key generator 405 to generate the dynamic key 465.

In an exemplary embodiment, the wireless device 400 may also comprise a web browser 416 and a wireless interface 418. The web browser 416 and the wireless interface 418 are shown in FIG. 4 in dotted line to indicate that they are optional. The web browser 416 allows the wireless device 400 to access web content and the wireless interface 418 allows the wireless device 400 to communicate with other wireless devices using a wireless channel. Types of wireless communication include, for example only, radio frequency (RF), infrared (IR), optical, and other technologies that may be implemented to allow the wireless device 400 to wirelessly communicate with other wireless devices.

An exterior input device 422 can also be coupled to the system bus 408 to allow the wireless device 400 to receive other types of input. For example, the exterior input device 422 may comprise a proximity sensor to detect the presence of other wireless devices.

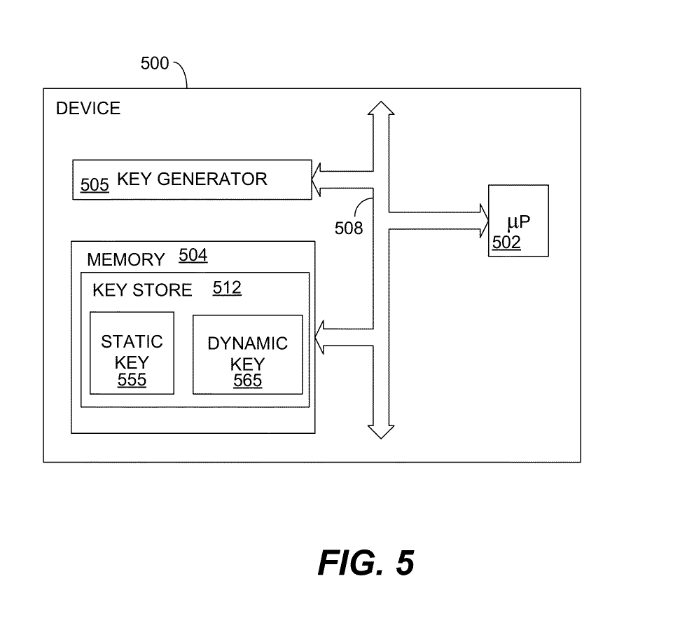

FIG. 5 is a block diagram illustrating another exemplary embodiment of a wireless device 500 in which aspects of the system for implementing enhanced secure identity generation can be implemented. In an embodiment, the wireless device 500 can be a “Bluetooth” wireless communication device, a portable cellular telephone, a WiFi enabled communication device, a wearable device, such as a ring, or can be any other electronic device. The wireless device 500 illustrated in FIG. 5 is intended to be a simplified example of a wearable device that can comprise exemplary embodiments of the system for implementing enhanced secure identity generation and that may include any of a static authentication key and a dynamic authentication key.

In an embodiment, the wireless device 500 includes a processor 502, a memory 504 and a key generator 505 operatively connected over a system bus 508. The system bus 508 can comprise physical and logical connections that couple the above-described elements together and enable their interoperability.

The memory 504 can be volatile or non-volatile memory, and in an embodiment, can be non-volatile memory that contains a key store 512. In an exemplary embodiment, the key store 512 may store a static key 555 and/or a dynamic key 565. In an exemplary embodiment, the static key 555 can be an RFID tag, or can be any other persistent authentication key. In an exemplary embodiment, the dynamic key 565 can contain authentication information that is generated by the key generator 505 either once, or repeatedly, or can be a rolling key that changes based on time, or other factors. The processor 502 can be any processor that executes the key generator 505 to generate the static key 555. In an exemplary embodiment, the wireless device 500 is a passive device that operates in similar manner as an RFID tag.

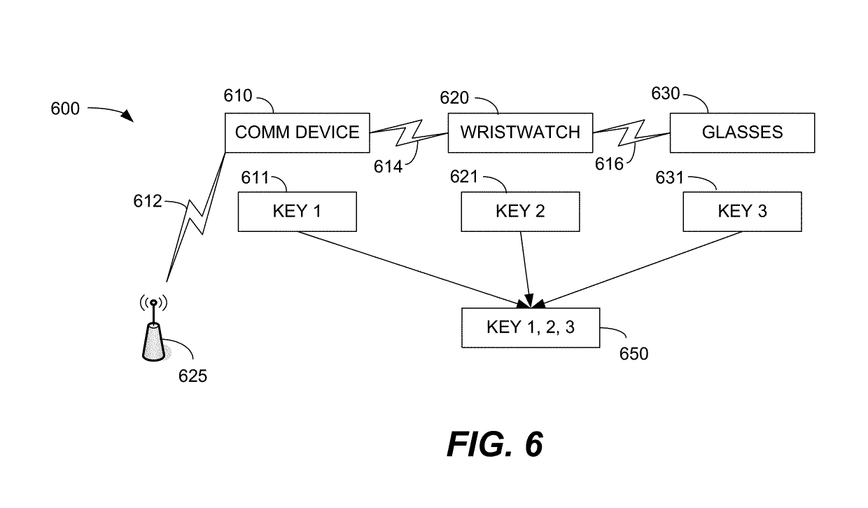

FIG. 6 is a schematic diagram illustrating an exemplary embodiment of a system for implementing enhanced secure identity generation. The system 600 comprises user devices 610, 620 and 630, and respective authentication keys 611, 621 and 631 that can represent authentication levels of the three different user devices 610, 620 and 630, respectively. In an exemplary embodiment, an implementation makes use of location-aware or proximity-aware “beacon” devices, an exemplary of which is illustrated using reference numeral 625. A beacon device 625 could be a wearable or portable item, such as a watch, a shoe, a jacket, or another device that is beacon enabled. The beacon 625 can transmit a secure code over, for example, wireless connection 612, that is resolved to a specific device ID. In such a case, a wireless device 610 such as a mobile phone or tablet could generate an authentication key 611 based on data on the wireless device 610 and the set of proximate beacon devices 625 and their underlying IDs. This key data could then be used to generate an enhanced authentication key 650 for both local and remote identification and authentication of the owner of the user device 610. Access to the device, application or service would thus rely on the ability to regenerate the correct key. Should the handset/tablet fail to detect one or more of the required beacons, the computation would result in an invalid key and access would be denied.

In addition, the proximity of the devices 610, 620 and 630 could be used to generate the enhanced authentication key 650. For example, in such a proximity-based implementation, only if the user devices 610, 620 and 630 are proximate to each other, based on, for example, a wireless communication signal transmitted by each device to each other device over exemplary wireless connections 614 and 616 within a defined period of time, would the enhanced authentication key 650 be generated. Key data may be generated based on the presence of a group of people relative to proximity information that is specific to the group or object(s).

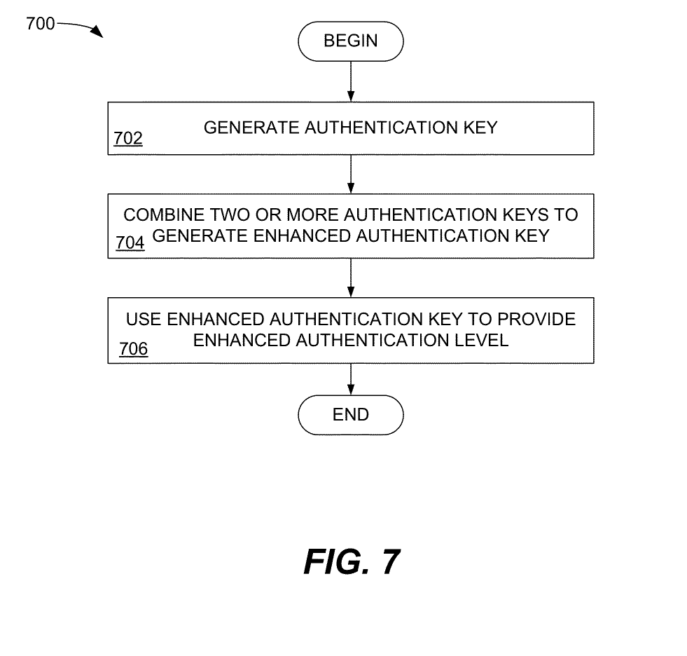

FIG. 7 is a flow chart 700 describing the operation of an embodiment of a method for implementing enhanced secure identity generation.

The blocks in the flow chart 700 can be performed in or out of the order shown.

In block 702, an authentication key is generated by a user device. Alternatively, an authentication key can be stored in a user device.

In block 704, two or more authentication keys are combined to generate an enhanced authentication key having an authentication level and privileges higher that an authentication level and privileges of either of the two authentication keys alone used to generate the enhanced authentication key.

In block 706, the enhanced authentication key is used to provide an enhanced authentication level of access higher than an authentication access level provided by any of the original authentication keys.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

1. An authentication system, comprising:
a first authentication key associated with a first device, the first authentication key having a corresponding authentication level;
a second authentication key associated with a second device, the second authentication key having a corresponding authentication level; and
an enhanced authentication key generated when the first and second authentication keys are combined, the enhanced authentication key having an authentication level that represents a higher authentication level than the authentication level of the first authentication key and the authentication level of the second authentication key.

2. The system of claim 1, wherein each of the first and second authentication keys corresponds to an authentication level having respective first privileges.

3. The system of claim 2, wherein the enhanced authentication key corresponds to an authentication level having second privileges.

4. The system of claim 3, wherein the enhanced authentication key is generated when with the first device is proximate to the second device by wireless communication directly between the first device and second device.

5. The system of claim 3, wherein the enhanced authentication key is generated when the first device and the second device are proximate to a geographical region.

6. The system of claim 3, wherein the enhanced authentication key is generated based on time of day.

7. The system of claim 3, wherein the enhanced authentication key is a static key.

8. The system of claim 3, wherein the enhanced authentication key is a dynamic key.

9. A method, comprising:
generating a plurality of authentication keys, each authentication key having a corresponding authentication level; and
combining at least two of the authentication keys to generate an enhanced authentication key, the enhanced authentication key having an authentication level that represents a higher authentication level than the authentication level of any of the plurality of authentication keys.

10. The method of claim 9, wherein each of the plurality of authentication keys corresponds to an authentication level having first privileges.

11. The method of claim 10, wherein the enhanced authentication key corresponds to an authentication level having second privileges.

12. The method of claim 11, further comprising generating the enhanced authentication key when a first device having a first authentication key is proximate to a second device having a second authentication key by wireless communication directly between the first device and second device.

13. The method of claim 11, further comprising generating the enhanced authentication key when a first device having a first authentication key and a second device having a second authentication key are proximate to a geographical region.

14. The method of claim 11, further comprising generating the enhanced authentication key based on time of day.

15. The method of claim 11, wherein the enhanced authentication key is a static key.

16. The method of claim 11, wherein the enhanced authentication key is a dynamic key.

17. A system, comprising:
means for generating a plurality of authentication keys, each authentication key having a corresponding authentication level; and
means for combining at least two of the authentication keys to generate an enhanced authentication key, the enhanced authentication key having an authentication level that represents a higher authentication level than the authentication level of any of the plurality of authentication keys.

18. The system of claim 17, further comprising means for generating the enhanced authentication key when a first device having a first authentication key is proximate to a second device having a second authentication key by wireless communication directly between the first device and second device.

19. The system of claim 17, further comprising means for generating the enhanced authentication key when a first device having a first authentication key and a second device having a second authentication key are proximate to a geographical region.

20. The system of claim 17, further comprising means for generating the enhanced authentication key based on time of day.
